(19) United States
(12) Patent Application Publication
(10) Pub. No.: US 2025/0315528 A1
(43) Pub. Date: Oct. 9, 2025

(54) MEMORY CONTROLLER, STORAGE DEVICE, AND OPERATING METHOD OF STORAGE DEVICE

(71) Applicant: Samsung Electronics Co., Ltd., Suwon-si (KR)

(72) Inventors: Hyunjoon YOO, Suwon-si (KR); Youngsik MOON, Suwon-si (KR); Wijik LEE, Suwon-si (KR)

(73) Assignee: Samsung Electronics Co., Ltd., Suwon-si (KR)

(21) Appl. No.: 19/006,551

(22) Filed: Dec. 31, 2024

(30) Foreign Application Priority Data
Apr. 3, 2024 (KR) 10-2024-0045521

(51) Int. Cl. G06F 21/56

(52) U.S. Cl. CPC G06F 21/566; G06F 2221/034

(57) ABSTRACT

A storage device may include a non-volatile memory device including a plurality of memory blocks, and processing circuitry configured to determine whether data associated with a memory operation received from a host device is infected with ransomware, the determining whether the data is infected with ransomware including, determining a first detection result value by calculating a distribution of bit values in the data, and outputting a second detection result value by detecting a similarity of the memory operation received from the host device with a memory operation transmitted by the processing circuitry to the non-volatile memory device in response to the first detection result value being less than or equal to a first threshold.

### CROSS-REFERENCE TO RELATED APPLICATION

This U.S. non-provisional application is based on and claims the benefit of priority under 35 U.S.C. § 119 to Korean Patent Application No. 10-2024-0045521, filed on Apr. 3, 2024, in the Korean Intellectual Property Office, the disclosure of which is incorporated by reference herein in its entirety.

### BACKGROUND

Various example embodiments of the inventive concepts relate to an electronic device, and more particularly, to a memory controller for detecting ransomware executed on a solid state drive (SSD), a storage device, a system including the storage device, and/or a method of operating the storage device, etc.

Ransomware is a type of malware which encrypts a user's data without the user's authorization and then the ransomware installer threatens the user by demanding payment in exchange for the decryption keys to recover the maliciously encrypted data. Since the amount of damage caused by ransomware is continuously increasing, the desire and/or need for solutions is increasing, and as one of the solutions, backup technology to defend against ransomware attacks has been actively studied. Traditionally, backups have been performed at the host level. However, performing an explicit backup for a copy has the disadvantages that additional storage space is required as a result to store the backup copies, the backup copies may also be destroyed if the operating system (OS) is damaged, and/or the backup copies may also be infected by the malware, etc.

In contrast, backup technology in the SSD storage level is space-efficient and safe, even when the OS is damaged and/or corrupted. Backup technology on the SSD does not desire and/or require explicit space for backup copies because backup technology retains data pages that are invalidated by the SSD's overwrite as backups. In addition, SSD firmware is separate from the OS. Therefore, even if the host OS is corrupted by unauthorized ransomware, the copy may be kept secure.

In order to defend against ransomware attacks, the SSD may perform ransomware detection that detects whether ransomware is included in the data requested for the overwrite whenever an overwrite request for the page occurs.

### SUMMARY

Various example embodiments of the inventive concepts provide a memory controller, a storage device, a system including the storage device, and/or a method of operating the storage device, which may detect ransomware infection on a solid state drive (SSD), quickly determine whether there is ransomware infection in the first instance, and subsequently accurately determine whether there is ransomware infection based on the results of the determination.

According to at least one example embodiment of the inventive concepts, there is provided a storage device including a non-volatile memory device including a plurality of memory blocks, and processing circuitry configured to, determine whether data associated with a memory operation received from a host device is infected with ransomware, the determining whether the data is infected with ransomware including, determining a first detection result value by calculating a distribution of bit values in the data, and outputting a second detection result value by detecting a similarity of the memory operation received from the host device with a memory operation transmitted by the processing circuitry to the non-volatile memory device in response to the first detection result value being less than or equal to a first threshold.

According to at least one example embodiment of the inventive concepts, there is provided a method of operating a storage device, the method including receiving a write command from a host device, the write command including data to be written to a storage device, performing a first ransomware detection operation on the data, the first ransomware detection operation including determining a distribution of bit values included in the data, performing a second ransomware detection operation based on a first ransomware detection result of the first ransomware detection operation, a first threshold, and a second threshold, the second ransomware detection operation including determining a similarity score of the write command received from the host device and a write command transmitted to non-volatile memory included in the storage device, and determining whether the data is infected with ransomware based on a second ransomware detection result of the second ransomware detection operation, a third threshold, and a fourth threshold.

According to at least one example embodiment of the inventive concepts, there is provided a memory controller including a buffer memory configured to store data corresponding to a logical block address received from a host device, and processing circuitry configured to, output a first ransomware detection result value based on a calculation of a distribution of bit values data associated with a memory command received from the host device, and output a second ransomware detection result value based on a detected similarity of the memory command received from the host device and a memory command transmitted to a non-volatile memory.

### BRIEF DESCRIPTION OF THE DRAWINGS

FIG. 1 is a block diagram schematically illustrating a storage system according to at least one example embodiment;

FIG. 2 is a block diagram specifically illustrating a storage system according to at least one example embodiment;

FIG. 3 is a block diagram illustrating a host-storage system according to at least one example embodiment;

FIG. 4 is a flowchart schematically illustrating a method of operating a storage device according to at least one example embodiment;

FIG. 5 is a flowchart specifically illustrating a method of operating a storage device according to at least one example embodiment;

FIG. 6 is a flowchart illustrating a method of operating a storage device according to at least one example embodiment.

FIG. 7 is a block diagram illustrating a non-volatile memory device according to at least one example embodiment;

FIG. 8 is a block diagram illustrating an electronic system to which a storage device according to at least one example embodiment is applied; and

FIG. 9 is a block diagram illustrating a data center to which a storage device according to some example embodiments is applied.

### DETAILED DESCRIPTION

Hereinafter, various example embodiments of the inventive concepts will be described in detail with reference to the accompanying drawings.

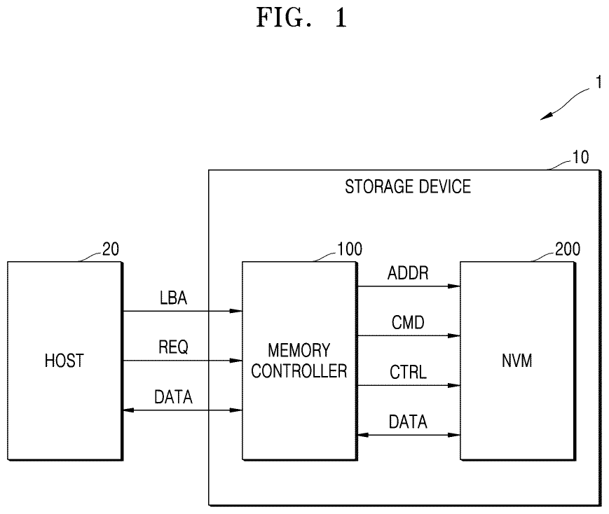

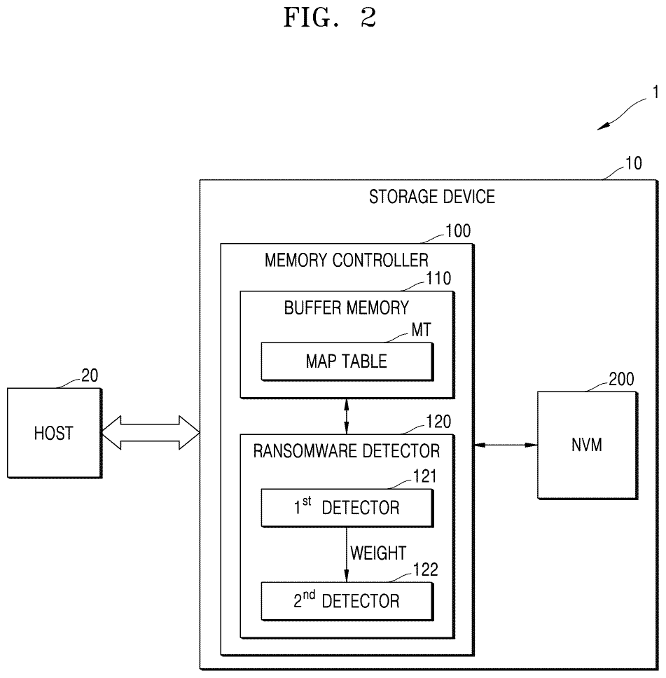

FIG. 1 is a block diagram schematically illustrating a storage system 1 according to at least one example embodiment. FIG. 2 is a block diagram specifically illustrating a storage system 1 according to at least one example embodiment.

Referring to FIGS. 1 and 2, the storage system 1 may include at least one host 20 (e.g., host device, host computer, etc.) and at least one storage device 10, but the example embodiments are not limited thereto, and for example, the storage system 1 may include a greater or lesser number of constituent components. The host 20 and the storage device 10 may be electrically and/or communicatively connected to each other. The host 20 may communicate with the storage device 10 through at least one interface. Here, the interface may be implemented as, for example, nonvolatile memory express (NVMe), NVMe Management Interface (MI), NVMe Over Fabric (NVMeof), etc., but is not limited thereto. Additionally, according to some example embodiments, the host 20 may communicate with the storage device 10 through other wired interfaces, such as USB, etc., and/or wireless interfaces, e.g., WiFi, Bluetooth, 4G, 5G, 6G, etc.

The host 20 may provide at least one memory operation including a logical block address (LBA) and/or a request signal (REQ), etc., to the storage device 10, and the host 20 and the storage device 10 may exchange data therebetween in response to the memory operation (e.g., the LBA and/or REQ, etc.). For example, the host 20 may provide the storage device 10 with an overwrite request requesting the storage device 10 to store data, etc. Unlike a general write command including new data information, the host 20 may generate a write command including information corresponding to existing data and provide the overwrite command to the storage device 10. In at least one example embodiment, a write command including both information on new data and information on existing data may be referred to as an overwrite request. Overwrite processing may refer to an operation of writing new data at a location different from a location where the existing data is written and invalidating the existing data. In addition, the host 20 may provide a logical block address LBA and data for identifying data to the storage device 10. In at least one example embodiment, the logical block address LBA may be included in the overwrite request, etc. Data DATA provided from the host 20 may be referred to as host data.

The storage device 10 may include one or more storage media for storing data DATA in response to a write and/or overwrite request from the host 20, etc. For example, the storage device 10 may include at least one of a solid state drive (SSD), an embedded memory, and/or a detachable external memory, etc., but is not limited thereto. When the storage device 10 is an SSD, the storage device 10 may be a device that follows, e.g., non-volatile memory express (NVMe) specifications, etc., but is not limited thereto. When the storage device 10 is an embedded memory and/or an external memory, the storage device 10 may be a device that follows, e.g., a universal flash storage (UFS), embedded multi-media card (eMMC) specifications, etc., but is not limited thereto. Each of the host 20 and the storage device 10 may generate and/or transmit packets according to adopted standard protocols.

The storage device 10 may include a memory controller 100 and/or a non-volatile memory device 200, etc., but is not limited thereto.

The memory controller 100 may control the overall operation of the storage device 10. The memory controller 100 may be referred to as processing circuitry, a controller, a device controller, and/or a storage controller, etc. For example, the memory controller 100 may be connected to the non-volatile memory device 200 to control the non-volatile memory device 200, but is not limited thereto. For example, the memory controller 100 may provide an address ADDR, a command CMD, a control signal CTRL, and the like to the non-volatile memory device 200 in response to the logical block address LBA, the request signal REQ, and the like received from the host, etc. That is, the memory controller 100 may provide signals to the non-volatile memory device 200 to control writing data to the non-volatile memory device 200 and/or reading data from the non-volatile memory device 200, etc. According to some example embodiments, the memory controller 100, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

When power is applied to the storage device 10 from the outside (e.g., an external source), the memory controller 100 may execute firmware (e.g., computer readable instructions, etc.). When the non-volatile memory device 200 is a flash memory device, the firmware may include computer readable instructions corresponding to a host interface layer (HIL), a flash translation layer (FTL), and/or a flash interface layer (FIL), etc., which may be executed by the memory controller 100, etc.

The memory controller 100 may control the non-volatile memory device 200 to perform a program operation (and/or a write operation, etc.) in response to an overwrite request from the host 20. During a program operation, the memory controller 100 may provide a program command (and/or a write command, etc.) and data to the non-volatile memory device 200. The memory controller 100 may transmit its own generated command CMD, address ADDR, and/or data DATA, etc., to the non-volatile memory device 200 regardless of the request provided from the host 20. For example, the memory controller 100 may generate a command CMD, an address ADDR, and/or data DATA, etc., for performing a background operation, and may provide the command CMD, the address ADDR, the control signal CTRL, and/or the data DATA, etc., to the non-volatile memory device 200. The background operation may be, for example, a wear leveling operation, a read reclaim operation, and/or garbage collection operation, etc., but is not limited thereto.

The memory controller 100 may include a buffer memory 110 and a ransomware detector 120, and the ransomware detector 120 may include a first detector 121 and a second detector 122, but the example embodiments are not limited thereto. In at least one example embodiment, the ransomware detector 120 may be implemented as a flash conversion layer, but is not limited thereto. According to at least one example embodiment, the memory controller 100 may be implemented as a field programmable gate array (FPGA), but is not limited thereto. For example, the FPGA may include the memory controller 100, and may perform ransomware detection on data provided from outside, such as a host, in a separate area and/or a secure area. For example, the FPGA may include the memory controller 100 and the ransomware detector 120, and the ransomware detector 120 may perform ransomware detection on data provided from outside (e.g., an external source), such as a host, etc. In addition, for example, the FPGA may perform the same function as the memory controller 100, and the memory controller 100 may perform ransomware detection on data provided from outside (e.g., an external source), such as a host, etc. According to some example embodiments, the memory controller 100, buffer memory 110, ransomware detector 120, first detector 121, and/or second detector 122, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The buffer memory 110 may store data DATA. The buffer memory 110 may be implemented as, for example, a volatile memory, but is not limited thereto. The volatile memory may operate in response to the control of the memory controller 100 only while power is supplied to the volatile memory. Specifically, the volatile memory may temporarily store data only while power is supplied. The volatile memory may include dynamic random access memory (DRAM), static random access memory (SRAM), and the like. The buffer memory 110 may be included in the memory controller 100 as illustrated in FIG. 2, but is not limited thereto. In at least one example embodiment, the buffer memory 110 may be arranged outside (e.g., external to) the memory controller 100.

The buffer memory 110 may further store map data. The map data may be data including information indicating a mapping relationship between a logical address and a physical address. Information indicating a mapping relationship between the logical address and the physical address may be referred to as map information.

The ransomware detector 120 may perform ransomware detection on data provided by the host 20. Here, the data may refer to data including data DATA, commands CMD, and the like, included in a memory operation issued by the host 20, etc. For example, the ransomware detector 120 may detect ransomware when there is an overwrite request from the host 20, but is not limited thereto, and may further include write operations, programming operations, etc. The ransomware detector 120 may detect ransomware infection of the data DATA using various detection algorithms. For example, the ransomware detector 120 may detect ransomware using similarity and/or entropy calculations, but is not limited thereto. In at least one example embodiment, the ransomware detector 120 may perform a first detection operation in the first detector 121 and then perform a second detection operation in the second detector 122 according to a detection result of the first detector 121.

The first detector 121 may receive data DATA from the host 20. The first detector 121 may determine a distribution of the data DATA. To detect the distribution of data, the first detector 121 may calculate the weight and/or distribution of 0 values and 1 values included in the data DATA, or in other words, the first detector 121 may determine the weight and/or distribution of the bit values and/or data values of the data associated with and/or corresponding to the memory operation from the host 20, etc. When the distribution of 0 values and 1 values in the data is disorderly, random, and/or unstable, the first detector 121 may determine that there is no ransomware infection, and when the distribution of 0 values and 1 values in the data is stable and/or uniform, the first detector 121 may determine that there is ransomware infection, but the example embodiments are not limited thereto. For example, when a first detection result value exceeds a first threshold (e.g., first desired threshold, first ransomware threshold, etc.), the first detector 121 may determine that there is no ransomware infection, and when the first detection result value is less than or equal to the first threshold, the first detector 121 may indicate that a ransomware infection is suspected and/or determined, etc. In other words, the first detector 121 may determine whether a ransomware infection is suspected based on the distribution of bit values and the first threshold, but the example embodiments are not limited thereto.

The first detector 121 may generate a weight based on the results of the first detection, and may provide the weight to the second detector 122. Only when the first detector 121 determines that there is ransomware infection, is the weight generated. For example, the first detector 121 may subsequently provide the weight to the second detector 122 before the second detector 122 performs the second detection operation.

In at least one example embodiment, the first detector 121 may compare the first detection result with a first threshold and a second threshold. The first threshold may be greater than the second threshold, but is not limited thereto. When the first detection result of the first detector 121 exceeds the first threshold, data may be programmed in the non-volatile memory device 200 due to the data being determined to be ransomware-free, and the additional operation of the second detector 122 may not be performed (e.g., may be omitted). When the first detection result of the first detector 121 is less than or equal to the first threshold and greater than or equal to the second threshold (e.g., the first detection result is between the first threshold and the second threshold, etc.), data may be programmed into the non-volatile memory device 200, and the original data stored in the non-volatile memory device 200 may be managed to not be invalidated (e.g., the original data is not invalidated). In addition, the second detection operation may be performed by the second detector 122, which is a subsequent operation to the first detector 121. The first detector 121 may generate a weight based on the first detection result and may provide the weight to the second detector 122, but is not limited thereto. When the first detection result of the first detector 121 is less than the second threshold, data may be stored in the buffer memory 110 and the second detector 122 may perform a second detection operation. The first detector 121 may generate a weight based on the first detection result and may provide the weight to the second detector 122. That is, the first detector 121 may calculate a data distribution of the data to be written so that the first detector 121 may quickly determine whether the data to be written provided by the host 20 is infected with ransomware.

The second detector 122 may receive a command (e.g., a ransomware verification request, etc.) from the host 20, but is not limited thereto, and for example, the second detector 122 may receive the command from the first detector 121 and/or the memory controller 100, etc. The second detector 122 may receive a weight from the first detector 121 in response to and/or in association with the received command, etc. The second detector 122 may determine a similarity score based on the command. The similarity may refer to the difference, for example, at a byte-level, etc., between the command provided by the host 20 to the memory controller 100 and a command to be provided by the memory controller 100 to the non-volatile memory device 200. In at least one example embodiment, the second detector 122 may detect a similarity score of the command provided by the host. For example, the detecting the similarity score (e.g., second detection result, second detection result value, etc.) of the command may include determining a command order (e.g., an ordering of and/or sequence of previously transmitted memory operations, etc.) between the host 20 to the memory controller 100 and the command order between the memory controller 100 and the non-volatile memory device 200, but the example embodiments are not limited thereto. When the order (e.g., sequence) of the commands from the host is similar to and/or the same as the order (e.g., sequence) of the commands provided by the memory controller 100 to the non-volatile memory device 200, the second detector 122 may determine that there is no ransomware infection, and when the former is not similar to and/or the same as the latter, the second detector 122 may determine that there is a ransomware infection, but the example embodiments are not limited thereto. For example, when a second detection result value of the second detector 122 exceeds a third threshold, the second detector 122 may determine that there is no ransomware infection, and when the second detection result value is less than or equal to the third threshold, the second detector 122 may determine that the data is suspected ransomware and/or determine that the data is infected with ransomware.

In at least one example embodiment, the second detector 122 may compare the second detection result with the third threshold and/or a fourth threshold, but the example embodiments are not limited thereto. For example, the third threshold may be greater than the fourth threshold. When the second detection result of the second detector 122 exceeds the third threshold, data may be programmed (e.g., written, stored, etc.) in the non-volatile memory device 200. Here, the second detection result may be a value reflecting a weight. When the second detection result of the second detector 122 is less than or equal to the third threshold and greater than or equal to the fourth threshold, the new data to be written into the non-volatile memory device 200 may be programmed (e.g., written, stored, etc.) into the non-volatile memory device 200, and the original data already stored in the non-volatile memory device 200 may be managed so as to not to invalidated (e.g., be temporarily preserved, etc.). When the second detection result of the second detector 122 is less than the fourth threshold, the programming operation of the new data to be written into the non-volatile memory device 200 may be omitted and the original data stored in the non-volatile memory device 200 may not be invalidated. That is, the second detector 122 may determine the similarity of the command operations received by the memory controller and the non-volatile memory, respectively, to accurately determine whether data provided from the host 20 is infected with ransomware.

According to a comparative example, the ransomware detector 120 determines whether there is ransomware infection with only one of the first detector 121 or the second detector 122. The first detection operation of the first detector 121 may quickly determine whether ransomware is detected, but there is a problem in that the accuracy of the ransomware detection is low. The second detection operation of the second detector 122 may accurately determine and/or increase the accuracy of determining whether ransomware is detected in the data being analyzed, but there is a problem in that the speed of the ransomware detection is slow and/or slower, due to the two detection operations always being performed.

However, according to at least one example embodiment, the ransomware detector 120 may determine whether there is ransomware infection in data to be written to the memory device using the first detector 121 and the second detector 122. It may be initially determined whether ransomware in the data has been detected using the first detection operation of the first detector 121, and when the first detection result value is less than or equal to the first threshold, after having compared the first detection result value with the first threshold, it may be secondarily determined whether the ransomware has been detected in the data to be written using the second detection operation of the second detector 122. That is, the ransomware detector 120 sequentially performs the first detection operation in the first detector 121, and when it is suspected that there is ransomware infection according to the result value of the first detection operation, the second detector 122 may perform the second detection operation to finally determine whether there is ransomware infection.

In addition, according to at least one example embodiment, ransomware may be detected by the storage device 10 other than the host 20, therefore the ransomware detector 120 may quickly determine whether there is an initial ransomware infection through the first detector 121, and when it is suspected that there is a ransomware infection, the ransomware detector 120 may selectively confirm the ransomware infection through the second detector 122.

The non-volatile memory device 200 may operate in response to the control of the memory controller 100, but is not limited thereto. Specifically, the non-volatile memory device 200 may receive a command CMD and an address ADDR from the memory controller 100 and access a memory cell selected by the address ADDR from among the memory cells. The non-volatile memory device 200 may perform at least one operation instructed by the command CMD on the memory cell selected by the address ADDR.

The non-volatile memory device 200 may be, for example, a flash memory, but is not limited thereto. The flash memory may include, for example, a NAND flash memory, a NOR flash memory, and the like. When the non-volatile memory device 200 includes a flash memory, the flash memory may include a 2D NAND memory array and/or a 3D (or vertical) NAND (VNAND) memory array, etc.

In at least one example embodiment, the storage device 10 may include various other types of non-volatile memory devices. For example, the storage device 100 may include magnetic RAM (MRAM), spin-transfer torque MRAM, conductive bridging RAM (CBRAM), ferroelectric RAM (FeRAM), phase-change RAM (PRAM), and/or other various types of memories.

The non-volatile memory device 200 may include a plurality of memory blocks. The plurality of memory blocks may include at least one user memory block and at least one meta memory block. The user memory block may be a memory block in which user data may be stored. The user data may include data provided from the host 20. The meta memory block may be a memory block in which meta data may be stored. The metadata may be data on user data.

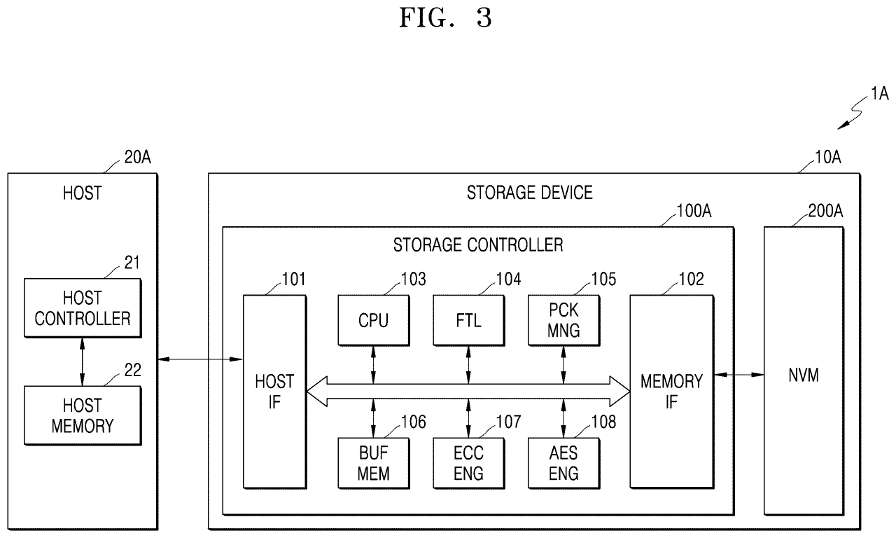

FIG. 3 is a block diagram illustrating a host-storage system 1A according to at least one example embodiment.

Referring to FIG. 3, the host-storage system 1A may include at least one host 20A and at least one storage device 10A, etc., but is not limited thereto. In addition, the storage device 10A may include at least one storage controller 100A and/or at least one non-volatile memory 200A, etc., but is not limited thereto. The host 20A may correspond to the host 20 illustrated in FIGS. 1 and 2, and the storage device 10A may correspond to the storage device 10 illustrated in FIGS. 1 and 2, but the example embodiments are not limited thereto.

In addition, according to at least one example embodiment, the host 20A may include at least one host controller 21 (e.g., processing circuitry, etc.) and/or at least one host memory 22, etc. The host memory 22 may function as a buffer memory for temporarily storing data to be transmitted to the storage device 10A and/or data transmitted from the storage device 10A, but is not limited thereto.

The storage device 10A may include storage media for storing data according to and/or based on at least one request from the host 20A. For example, the storage device 10A may include at least one of an SSD, an embedded memory, and/or a detachable external memory, etc. When the storage device 10A is an SSD, the storage device 10A may be a device that follows non-volatile memory express (NVMe) specifications, but is not limited thereto. When the storage device 10A is an embedded memory and/or an external memory, the storage device 10A may be a device that follows UFS and/or eMMC specifications, but is not limited thereto. Each of the host 20A and the storage device 10A may generate and/or transmit packets according to adopted standard protocols, etc.

When the non-volatile memory device 200A of the storage device 10A includes a flash memory, the flash memory may include a 2D NAND memory array and/or a 3D (or vertical) NAND (VNAND) memory array, etc. In at least one example embodiment, the storage device 10A may include various other types of non-volatile memories. For example, the storage device 10A may include MRAM, spin-transfer torque MRAM, CBRAM, FeRAM, PRAM, resistive RAM, and/or other various types of memories.

According to at least one example embodiment, the host controller 21 and the host memory 22 may be implemented as separate semiconductor chips. Additionally, or alternatively, in some example embodiments, the host controller 21 and the host memory 22 may be integrated into the same semiconductor chip. For example, the host controller 21 may be any one of a plurality of modules provided in an application processor, and the application processor may be implemented as a System on Chip (SoC), but is not limited thereto. In addition, the host memory 22 may be an embedded memory provided in the application processor, and/or a non-volatile memory and/or memory module placed outside the application processor, etc.

The host controller 21 may manage at least one operation of storing data (e.g., write data, etc.) of a buffer area of the host memory 22 in the non-volatile memory 200A and/or storing data (e.g., read data) of the non-volatile memory 200A in a buffer area, etc.

The storage controller 100A may include a host interface 101, a memory interface 102, and/or a central processing unit (CPU) 103, etc., but is not limited thereto. In addition, the storage controller 100A may further include an FTL 104, a packet manager 105, a buffer memory 106, an error correction code (ECC) engine 107, and/or an advanced encryption standard (AES) engine 108, etc. The storage controller 100A may correspond to the memory controller 100 illustrated in FIGS. 1 and 2, and the buffer memory 106 may correspond to the buffer memory 110 illustrated in FIG. 2, but the example embodiments are not limited thereto. The FTL 104 may correspond to the ransomware detector 120 illustrated in FIG. 2, but is not limited thereto. According to some example embodiments, the storage controller 100A, host interface 101, memory interface 102, CPU 103, FTL 104, packet manager 105, buffer memory 106, ECC engine 107, and/or the AES engine 108, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The storage controller 100A may further include a working memory (not shown) to which the FTL 104 is loaded, and a write operation and/or a read operation, etc., for the non-volatile memory 200A may be controlled by the CPU 103 executing the FTL.

The host interface 101 may transmit and/or receive packets to and/or from the host 20A. A packet transmitted from the host 20A to the host interface 101 may include a command, data, and the like to be stored in the non-volatile memory 200A, and a packet transmitted from the host interface 101 to the host 20A may include a response to a command, data, and the like, read from the non-volatile memory 200A. The memory interface 102 may transmit data to be stored in the non-volatile memory 200A to the non-volatile memory 200A and/or receive data read from the non-volatile memory 200A, etc. The memory interface 102 may be implemented to comply with standard protocols such as toggle and/or open NAND flash interface (ONFI), etc., but is not limited thereto.

The FTL 104 may perform several functions, such as address mapping, wear-leveling, and/or garbage collection, etc., but is not limited thereto. The address mapping operation is an operation of converting a logical address received from the host 20A into a physical address used to physically store data in the non-volatile memory 200A. The wear-leveling is a technique for decreasing and/or preventing excessive deterioration of a specific block by uniformly using blocks in the non-volatile memory 200A, and may be implemented through firmware technology which balances erase counts of physical blocks. The garbage collection is a technique for improving and/or ensuring available capacity in the non-volatile memory 200A through a method of copying valid data of a block to a new block and then erasing the existing block.

The packet manager 105 may generate at least one packet according to and/or based on the protocol of the interface consulted with the host 20A, and/or may parse various types of information from the packet received from the host 20A. In addition, the buffer memory 106 may temporarily store data to be stored in non-volatile memory 200A and/or data to be read from the non-volatile memory 200A. The buffer memory 106 may be a component provided in the storage controller 100A, but may be arranged outside (e.g., external to) the storage controller 100A.

The ECC engine 107 may perform an error detection and/or correction function on read data read from the non-volatile memory 200A. More specifically, the ECC engine 107 may generate parity bits for write data to be stored in the non-volatile memory 200A, and the generated parity bits may be stored in the non-volatile memory 200A together with the write data. When reading data from the non-volatile memory 200A, the ECC engine 107 may correct errors in the read data using the parity bits read from the non-volatile memory 200A along with the read data, and may output the error-corrected read data.

The AES engine 108 may perform at least one of an encryption operation and/or a decryption operation on data input to the storage controller 100A using a symmetric-key algorithm.

According to at least one example embodiment, ransomware may be detected in the storage device 10 other than the host 20. The FTL 104 may include a ransomware detector (e.g., ransomware detector 120 in FIG. 2, etc.), may quickly determine whether there is a ransomware infection through the first detector 121, and may selectively accurately (e.g., with improved accuracy) determine whether there is ransomware infection through the second detector 122 if it is suspected there is ransomware infection based on the result of the first detection.

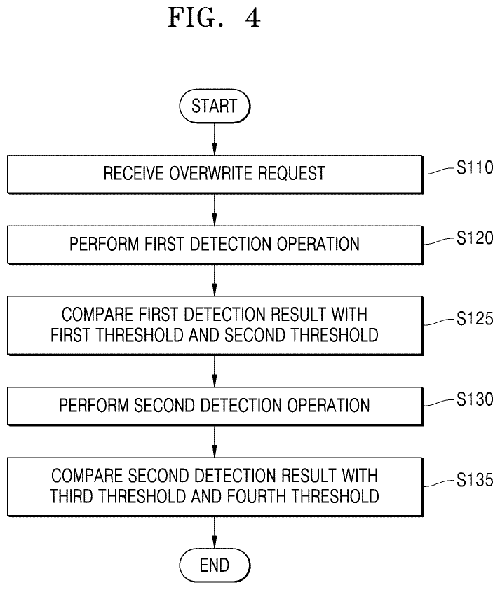

FIG. 4 is a flowchart schematically illustrating a method of operating a storage device according to at least one example embodiment. Hereinafter, the method of operating a storage device will be described with reference to FIGS. 1 to 4 together, but the example embodiments are not limited thereto.

Referring to FIG. 4, the storage device 10 may receive an overwrite request from the host 20 (S110). For example, the memory controller 100 of the storage device 10 may receive an overwrite request from the host 20.

The storage device 10 may perform the first detection operation (S120). For example, the first detector 121 may calculate a distribution of 0 values and 1 values of the data DATA provided by the host 20, or in other words, the first detector 121 may determine the distribution of data and/or bit values included in the data DATA included in and/or corresponding to the memory operation received from the host 20. As a result of performing the first detection operation of the first detector 121, a first detection result value may be output by the first detector 121.

The storage device 10 may compare the first detection result with a first threshold (e.g., a first desired threshold, a first ransomware threshold, an initial threshold, etc.) and a second threshold (e.g., a second desired threshold, a second ransomware threshold, a secondary threshold, etc.) (S125), but is not limited thereto. According to some example embodiments, the first threshold may be larger than the second threshold, but is not limited thereto. Additionally, when the first detection result value exceeds the first threshold, a second detection operation may not be performed and/or may be omitted. When the first detection result value is less than or equal to the first threshold and greater than or equal to the second threshold (e.g., the first detection result value is between the first threshold and the second threshold, etc.), or less than the second threshold, the second detection operation may be performed. In addition, the first detector 121 may generate a weight based on the first detection result value.

The storage device 10 may perform the second detection operation (S130). For example, the second detector 122 may determine a similarity based on at least one command provided from the host 20 and at least one command provided by the memory controller to the non-volatile memory of the storage device 10, etc. When the first detection result value of the first detector 121 is less than or equal to the first threshold (e.g., when the first detection result value is less than or equal to the first threshold and is greater than or equal to the second threshold, or when the first detection result value is less than the second threshold), the second detector 122 may perform a second detection operation. The second detector 122 may receive a weight from the first detector 121 before performing the second detection operation.

The storage device 10 may compare the second detection result with a third threshold and a fourth threshold (S135). For example, when the second detection result value exceeds the third threshold, data may be programmed, and when the second detection result value is less than or equal to the third threshold, greater than or equal to the fourth threshold, and less than the fourth threshold, the new data may be programmed, and original data may be managed to not be invalidated, or in other words, the original data may be maintained.

The storage device 10 according to at least one example embodiment may determine and/or quickly determine whether there is an increased risk and/or probability of an ransomware infection through the first detector 121, and may selectively determine whether there is a ransomware infection through the second detector 122 according to the first detection result value and the third and fourth threshold values, thereby increasing the accuracy of the ransomware detection.

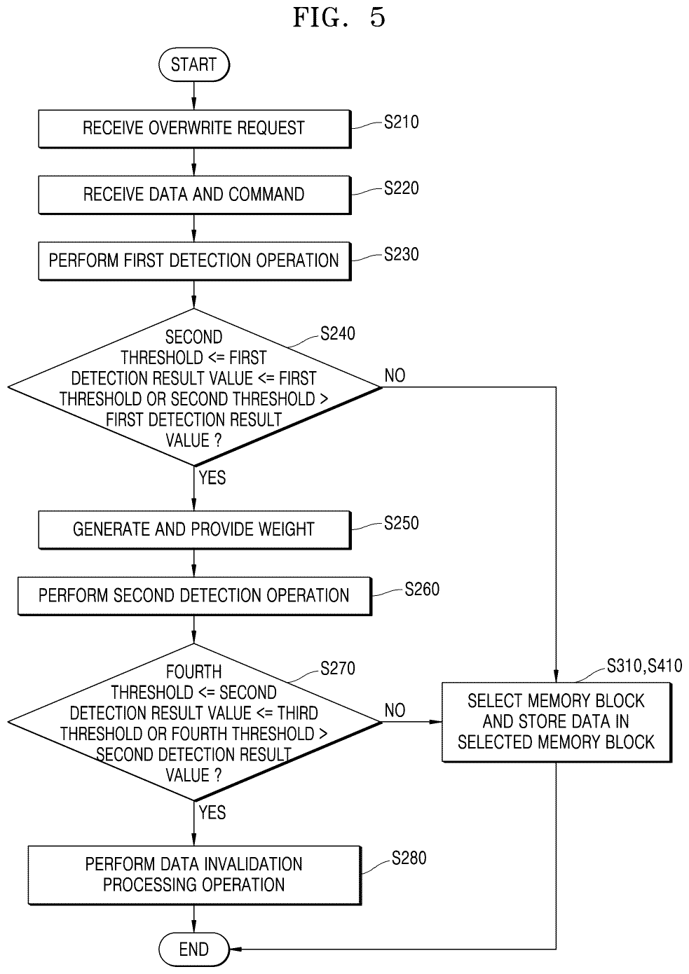

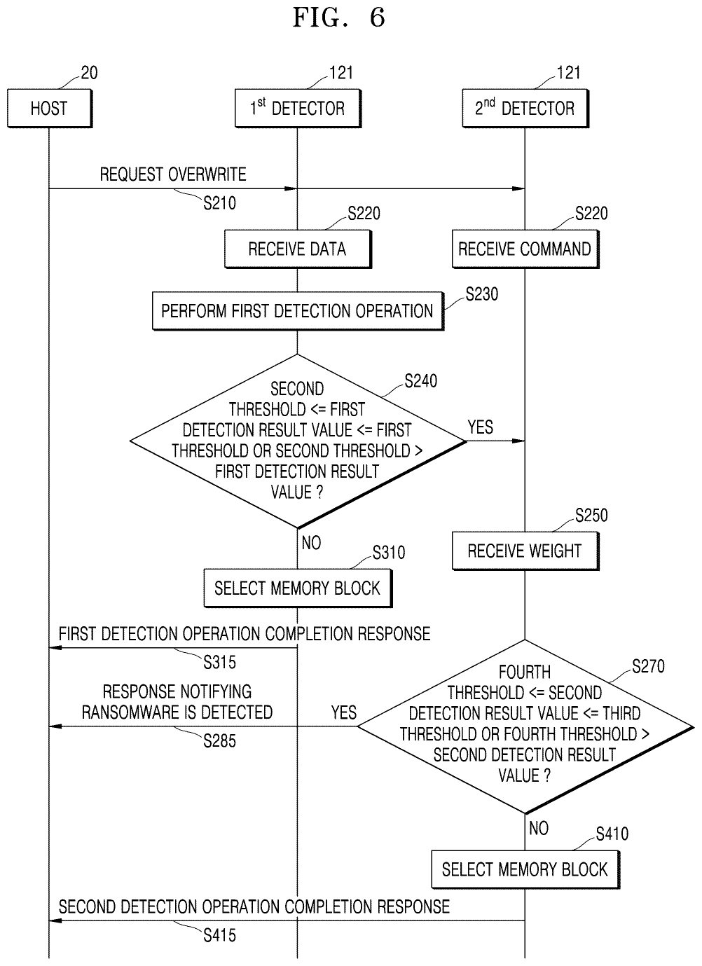

FIG. 5 is a flowchart specifically illustrating a method of operating a storage device according to at least one example embodiment. FIG. 6 is a flowchart illustrating a method of operating a storage device according to at least one example embodiment. In detail, FIGS. 5 and 6 are flowcharts illustrating a ransomware detection operation of the ransomware detector 120 of FIG. 2. Hereinafter, the ransomware detection operation will be described with reference to FIGS. 1 to 3, 5 and 6 together, but the example embodiments are not limited thereto.

Referring to FIGS. 5 and 6, the storage device 10 may receive an overwrite request from the host 20 (S210), but is not limited thereto. For example, the first detector 121 and/or the second detector 122 may receive an overwrite request from the host 20. The overwrite request may include a logical block address, etc. The storage device 10 may receive data DATA and/or a command CMD from the host 20 (S220). For example, the first detector 121 may receive data DATA from the host 20, and the second detector 122 may receive a command CMD from the host 20, but the example embodiments are not limited thereto.

The first detector 121 may perform a first detection operation (S230). The first detection operation may include calculating a distribution of bit values included in the data DATA provided by the host 20. For example, the first detector 121 may output a first detection result value as a result of performing the first detection operation for calculating the weight and/or distribution of 0 values and 1 values included in the data DATA, but is not limited thereto.

The first detector 121 may determine whether the first detection result value is less than or equal to a first threshold (e.g., a first desired threshold, etc.) and greater than or equal to a second threshold (e.g., a second desired threshold, etc.), or determine whether the first detection result value is less than the second threshold (S240). If the first detection result value is greater than the first threshold (NO in S240), the storage device 10 may select a memory block and store data in the selected memory block (S310). For example, operation S310 may include programming data in the non-volatile memory device 200. The first detector 121 may provide a first detection operation completion response to the host 20 (S315).

When the first detection result value is less than or equal to the first threshold and greater than or equal to the second threshold, or when the first detection result value is less than the second threshold (YES of S240), the first detector 121 may generate a weight and provide the generated weight to the second detector 122 (S250). For example, when the first detection result value is less than or equal to the first threshold and greater than or equal to the second threshold, or when the first detection result value is less than the second threshold, the first detector 121 may suspect that the data is infected with ransomware and/or is ransomware, etc. According to at least one example embodiment, when the first detection result of the first detector 121 is less than or equal to the first threshold and greater than or equal to the second threshold, data may be programmed (e.g., written, stored, etc.) in the non-volatile memory device 200, and the original data stored in the non-volatile memory device 200 may be managed to not be invalidated. Additionally, the first detector 121 may generate a weight and provide the weight to the second detector 122. According to at least one example embodiment, when the first detection result of the first detector 121 is less than the second threshold, data may be stored in the buffer memory 110, and the first detector 121 may generate a weight and provide the weight to the second detector 122.

The second detector 122 may perform a second detection operation (S260). For example, when the first detection result value of the first detector 121 is less than or equal to the first threshold and greater than or equal to the second threshold, or when the first detection result value is less than the second threshold, the second detector 122 may perform a second detection operation that is a subsequent operation. The second detection operation may include determining the similarity of the commands transmitted to the memory controller and the commands transmitted to the non-volatile memory based on the command CMD provided from the host 20. For example, as a result of performing a second detection operation for determining the similarity of the command CMD, the second detector 122 may output a second detection result value.

The second detector 121 may determine whether the second detection result value is less than or equal to the third threshold and greater than or equal to the fourth threshold, or determine whether the second detection result value is less than the fourth threshold (S270). If the second detection result value is greater than the third threshold (NO in S270), the storage device 10 may select a memory block and store data in the selected memory block (S410). For example, operation S410 may include programming (e.g., writing, storing, etc.) data in the non-volatile memory device 200. The second detector 122 may provide a second detection operation completion response to the host 20 (S415).

When the second detection result value is less than or equal to the third threshold and greater than or equal to the fourth threshold, or when the first detection result value is less than the fourth threshold (YES in S270), the second detector 122 may transmit a response indicating that ransomware was detected in the data to the host 20 (S285). For example, when the second detection result is less than or equal to the third threshold and greater than or equal to the fourth threshold, data may be programmed (e.g., written, stored, etc.) into the non-volatile memory device 200, and the original data stored in the non-volatile memory device 200 may be managed so as not to be invalidated. When the second detection result of the second detector 122 is less than the fourth threshold, the original data stored in the non-volatile memory device 200 may be managed to not be invalidated. That is, the second detector 122 may finally determine whether ransomware is detected (e.g., ransomware was detected in the data, etc.).

Accordingly, since the data provided by the host 20 is infected with ransomware, the memory controller 100 may perform an invalidation processing operation on the data (S280). In this case, the memory controller 100 may control the non-volatile memory device 200 to not program (e.g., write, store, etc.) the infected data (e.g., the data to be written to the non-volatile memory device 200), or in other words, delete and/or discard the ransomware infected data.

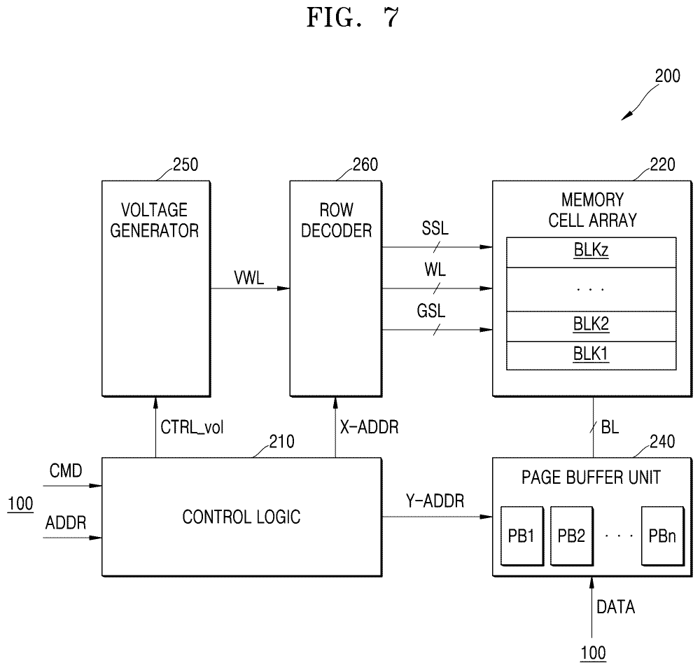

FIG. 7 is a block diagram illustrating a non-volatile memory device 200 according to at least one example embodiment.

Referring to FIG. 7, the non-volatile memory device 200 may include a control logic 210, a memory cell array 220, a page buffer unit 240, a voltage generator 250, and/or a row decoder 260, but is not limited thereto. The non-volatile memory device 200 according to at least one example embodiment may correspond to an example of the non-volatile memory device 200 of FIG. 1, and the features described with reference to FIGS. 1 to 6 may also be applied to the present example embodiment, but the example embodiments are not limited thereto.

In addition, although not shown in FIG. 7, the non-volatile memory device 200 may further include a memory interface circuit, and may also include a column logic, a pre-decoder, a temperature detector, a command decoder, an address decoder, etc., one or more of which may be implemented as processing circuitry, etc.

The control logic 210 may generally control various operations within the non-volatile memory device 200, etc. The control logic 210 may output various control signals in response to a command CMD and/or an address ADDR from the memory interface 102 of FIG. 3, but is not limited thereto. For example, the control logic 210 may output a voltage control signal CTRL_vol, a row address X-ADDR, and/or a column address Y-ADDR, etc., but is not limited thereto.

The memory cell array 220 may include a plurality of memory blocks BLKI to BLKz (where z is a positive integer), and each of the memory blocks BLKI to BLKz may include a plurality of memory cells. For example, the plurality of memory cells may be NAND flash memory cells. However, the example embodiments are not limited thereto, and in some example embodiments, the plurality of memory cells may include resistive memory cells such as ReRAM, PRAM, and/or MRAM, etc. The memory cell array 220 may be connected to the page buffer unit 240 through bit lines BL, and may be connected to the row decoder 260 through word lines WL, string selection lines SSL, and/or ground selection lines GSL, etc.

In at least one example embodiment, the memory cell array 220 may include a three-dimensional (3D) memory cell array, and the 3D memory cell array may include a plurality of NAND strings, but is not limited thereto. Each NAND string may include memory cells connected to word lines vertically stacked on a substrate. U.S. Pat. Nos. 7,679,133, 8,553,466, 8,654,587, 8,559,235, and U.S. Patent Application Publication No. 2011/0233648 are incorporated by reference herein in their entireties. In at least one example embodiment, the memory cell array 220 may include a two-dimensional memory cell array, and the two-dimensional memory cell array may include a plurality of NAND strings arranged in a row direction and a column direction.

The page buffer unit 240 may include a plurality of page buffers PB1 to PBn (n is an integer greater than or equal to 3), and the plurality of page buffers PB1 to PBn may be connected to memory cells through the plurality of bit lines BL, respectively. The page buffer unit 240 may select at least one bit line from among the bit lines BL in response to a column address Y-ADDR. The page buffer unit 240 may operate as a write driver and/or a sense amplifier depending on an operation mode of the memory device 200.

The voltage generator 250 may generate various types of voltages for performing program, read, and/or erase operations on the memory cell array 220 based on a voltage control signal CTRL_vol, etc. For example, the voltage generator 250 may generate a program voltage, a read voltage, a program verification voltage, an erase voltage, and the like, as a word line voltage VWL.

The row decoder 260 may select one of the plurality of word lines WL in response to a row address X-ADDR and may select one of the plurality of string selection lines SSL.

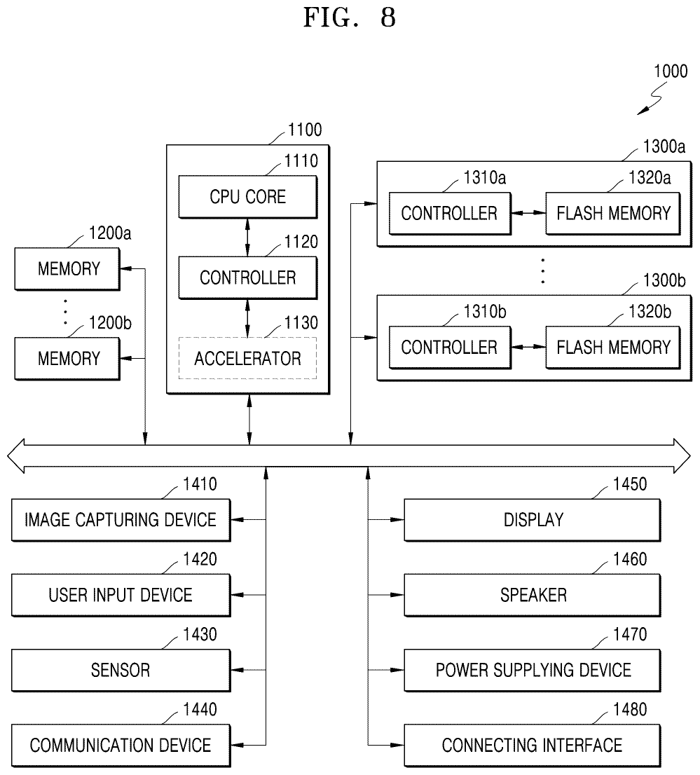

FIG. 8 is a block diagram illustrating an electronic system 1000 to which a storage device according to at least one example embodiment is applied.

Referring to FIG. 8, an electronic system 1000 may include a mobile system, such as a mobile phone, a smartphone, a tablet, a laptop computer, a wearable device, a healthcare device, and/or an Internet of Things (IoT) device, etc., but the example embodiments are not limited thereto. However, the electronic system 1000 is not necessarily limited to a mobile system and, for example, may include a personal computer, a server, a media player, a gaming console, and/or an automotive device such as a navigation, etc., but is not limited thereto.

The electronic system 1000 may include at least one main processor 1100, memories 1200a and 1200b, and/or storage devices 1300a and 1300b, etc., but is not limited thereto. In addition, the electronic system 1000 may include one or more of an image capturing device 1410, a user input device 1420, a sensor 1430, a communication device 1440, a display 1450, a speaker 1460, a power supplying device 1470, and/or a connecting interface 1480, etc.

The main processor 1100 may control the overall operation of the electronic system 1000, more specifically, the operation of other components comprising the electronic system 1000. The main processor 1100 may be implemented as a general-purpose processor, a dedicated processor, an application processor, or the like.

The main processor 1100 may include one or more CPU cores 1110 and may further include a controller 1120 for controlling the memories 1200a and 1200b and/or the storage devices 1300a and 1300b, etc. According to at least one example embodiment, the main processor 1100 may further include an accelerator 1130, which is a dedicated circuit for high-speed data operations such as an artificial intelligence (AI) data operation, etc., but is not limited thereto. For example, the accelerator 1130 may include a graphics processing unit (GPU), a neural processing unit (NPU), and/or a data processing unit (DPU), etc., and may be implemented as a separate chip physically independent of other components of the main processor 1100. According to some example embodiments, the main processor 1100, CPU cores 1110, controller 1120, and/or the accelerator 1130, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The memories 1200a and 1200b may be used as main memory devices of the electronic system 1000 and may include volatile memories, such as SRAM and/or DRAM, but may also include non-volatile memories, such as flash memory, PRAM and/or RRAM, etc. The memories 1200a and 1200b may be implemented in the same package as the main processor 1100.

The storage devices 1300a and 1300b may function as non-volatile storage devices that store data regardless of whether power is supplied to the storage devices, and may have a relatively large storage capacity compared to the memories 1200a and 1200b. The storage devices 1300a and 1300b may respectively include storage controllers 1310a and 1310b and non-volatile memories (NVM) 1320a and 1320b that store data under control of the storage controllers 1310a and 1310b. The non-volatile memories 1320a and 1320b may include flash memory having a 2-dimensional (2D) structure and/or a 3-dimensional (3D) Vertical NAND (V-NAND) structure but may include other types of non-volatile memories such as PRAM and/or RRAM, etc., but is not limited thereto.

The storage devices 1300a and 1300b may be included in the electronic system 1000 by being physically separate from the main processor 1100, and/or may be implemented in the same package as the main processor 1100. In addition, the storage devices 1300a and 1300b may be detachably combined with other components of the electronic system 1000 through an interface such as the connecting interface 1480, which is described below, by having a form such as a solid state device (SSD) and/or a memory card, etc. The storage devices 1300a and 1300b may be devices to which standard protocols such as UFS, eMMC, and/or NVMe, etc., are applied, but are not necessarily limited thereto.

The image capturing device 1410 may capture a still image and/or a moving image and may include a camera, a camcorder, and/or a webcam, etc. The user input device 1420 may receive various types of data input from a user of the electronic system 1000 and may include a touch pad, a keypad, a keyboard, a mouse, and/or a microphone, etc. The detector 1430 may detect various types of physical quantities that may be obtained from the outside of the electronic system 1000 and convert the detected physical quantities into electrical signals. The detector 1430 (e.g., sensor, etc.) may include a temperature detector, a pressure detector, an illuminance detector, a position detector, an acceleration detector, a biosensor, and/or a gyroscope detector, etc. The communication device 1440 may transmit and receive signals to and from other devices outside the electronic system 1000 according to various communication protocols. The communication device 1440 may be implemented by including an antenna, a transceiver, and/or a modem, etc.

The display 1450 and the speaker 1460 may function as output devices that output visual information and/or auditory information to users of the electronic system 1000, respectively. The power supplying device 1470 may appropriately convert power supplied from a battery (not shown) embedded in the electronic system 1000 and/or an external power source into the system 1000 and supply the power to each component of the electronic system 1000. The connecting interface 1480 may provide at least one connection between the electronic system 1000 and at least one external device connected to the electronic system 1000 and be capable of transmitting and receiving data to and from the electronic system 1000. The connecting interface 1480 may be implemented in a variety of interface methods such as Advanced Technology Attachment (ATA), Serial ATA (SATA), External SATA (e-SATA), Small Computer Small Interface (SCSI), Serial Attached SCSI (SAS), Peripheral Component Interconnection (PCI), PCI express (PCIe), NVMe, IEEE 1394, universal serial bus (USB), Secure Digital (SD) card interface, MMC, eUFS, Compact Flash (CF) card interface, and the like.

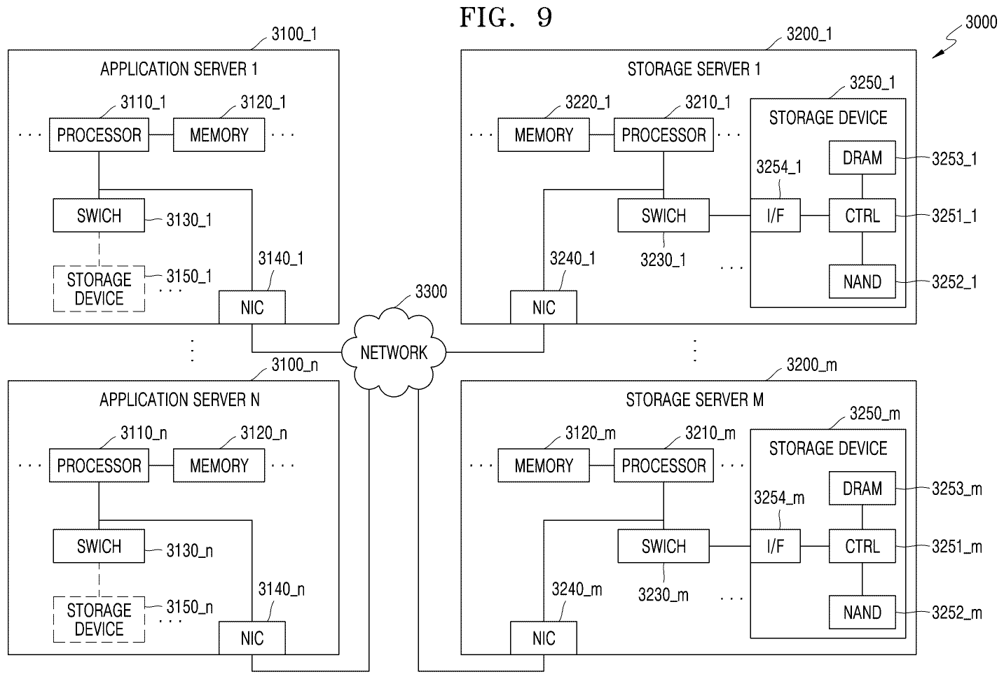

FIG. 9 is a block diagram illustrating a data center to which a storage device according to some example embodiments is applied.

Referring to FIG. 9, a data center 3000 is a facility which stores various types of data and/or provides services, and may also be referred to as a data storage center, a cloud server, a network storage server, etc. For example, the data center 3000 may be a system for operating a search engine and/or a database, etc., and may be a computing system used by companies, such as banks and/or government agencies, etc. The data center 3000 may include application servers 3100_1 to 3100_n and/or storage servers 3200_1 to 3200_m, but is not limited thereto. The number of application servers 3100_1 to 3100_n and the number of storage servers 3200_1 to 3200_m may be variously selected according to at least one example embodiment, and the number of application servers 3100_1 to 3100_n may be different from the number of storage servers 3200_1 to 3200_m.

The application server 3100_1 and/or the storage server 3200_1 may include one of processors 3110_1 and 3210_1 and one of memories 3120_1 and 3220_1. Taking the storage server 3200_1 as an example, the processor 3210_1 may control the overall operation of the storage server 3200_1, access the memory 3220_1, and execute instructions and/or data loaded into the memory 3220_1, etc. The memory 3220_1 may include, e.g., Double Data Rate Synchronous DRAM (DDR SDRAM), High Bandwidth Memory (HBM), Hybrid Memory Cube (HMC), Dual In-line Memory Module (DIMM), Optane DIMM, and/or Non-Volatile DIMM (NVMDIMM), etc. According to at least one example embodiment, the number of processors 3210_1 and the number of memories 3220_1 included in the storage server 3200_1 may be variously selected. In at least one example embodiment, the processor 3210_1 and the memory 3220_1 may provide a processor-memory pair. In at least one example embodiment, the number of processors 3210_1 may be different from the number of memories 3220_1. The processor 3210_1 may include a single core processor and/or a multi-core processor, etc. The description of the storage server 3200_1 may be similarly applied to the application server 3100_1. According to at least one example embodiment, the application server 3100_1 may omit a storage device 3150. The storage server 3200_1 may include at least one storage device 3250_1. The number of storage devices 3250_1 included in the storage server 3200_1 may be variously selected according to at least one example embodiment.

The first to N-th application servers 3100_1 to 3100_n and the first to M-th storage servers 3200_1 to 3200_m may communicate with each other through at least one network 3300. The network 3300 may be implemented using a wired medium, such as Fibre Channel (FC), Ethernet, or the like, and/or a wireless medium, such as WiFi, 4G, 5G, etc. In this case, the FC is a medium used for relatively high-speed data transmission, and an optical switch that provides high performance/high availability may be used. Depending on the access method of the network 3300, the storage servers 3200_1 to 3200_m may be provided as file storage, block storage, and/or object storage, etc.

In at least one example embodiment, the network 3300 may be a storage dedicated network, such as a storage area network (SAN), but is not limited thereto. For example, the SAN may be an FC-SAN implemented according to FC Protocol (FCP) using an FC network. As another example, the SAN may be an IP-SAN that uses a TCP/IP network and is implemented according to an SCSI over TCP/IP and/or Internet SCSI (iSCSI) protocol, etc. In at least one example embodiment, the network 3300 may be a general network such as a transmission control protocol (TCP)/internet protocol (IP) network. For example, the network 3300 may be implemented according to protocols such as FC over Ethernet (FCOE), Network Attached Storage (NAS), and/or NVMe over Fabrics (NVMe-oF), etc.

Hereinafter, the application server 3100_1 and the storage server 3200_1 will be described. However, the description of one application server 3100_1 may be applied to the other application server 3100_n, and the description of one storage server 3200_1 may be applied to the other storage server 3200_m, but are not limited thereto.

The application server 3100_1 may store data requested to be stored by a user and/or a client in one of the storage servers 3200_1 to 3200_m through the network 3300. In addition, the application server 3100_1 may acquire data requested to be read by at least one user and/or at least one client from one of the storage servers 3200_1 to 3200_m through the network 3300, ctc. For example, the application server 3100_1 may be implemented as a web server, a database management system (DBMS), or the like.

The application server 3100_1 may access the memory 3120_n and/or the storage device 3150_n included in the other application server 3100_n through the network 3300, and/or may access the memories 3220_1 to 320_m and/or the storage device 3250_1 to 3250_m included in the storage servers 3200_1 to 3200_m through the network 3300, etc. Thus, the application server 3100_1 may perform various operations on data stored in the application servers 3100_1 to 3100_n and/or the storage servers 3200_1 to 3200_m, etc. For example, the application server 3100_1 may execute at least one instruction for transferring and/or copying data between the application servers 3100_1-3100_n and/or the storage servers 3200_1-3200_m, etc. In this case, the data may be transferred from the storage device 3250_1-3250_m of the storage servers 3200_1-3200_m through the memories 3220_1-320_m of the storage servers 3200_1-3200_m, and/or directly to the memory 3120-3120n of the application servers 3100_1-3100_n, etc. Data which is transferred through the network 3300 may be data encrypted for security and/or privacy.

Taking the storage server 3200_1 as an example, an interface 3254_1 may provide at least one physical connection between the processor 3210_1 and/or a controller 3251_1 and/or a physical connection between a Network InterConnect (NIC) 3240_1 and/or the controller 3251_1, etc. For example, the interface 3254_1 may be implemented in a Direct Attached Storage (DAS) method that connects the storage device 3250_1 directly with at least one dedicated cable. In addition, for example, the interface 3254_1 may be implemented in various interface methods, such as ATA, SATA, e-SATA, SCSI, SAS, and PCI, PCIe, NVM express (NVMe), IEEE 1394, USB, SD card, multi-media card (MMC), eMMC, UFS, embedded Universal Flash Storage (cUFS), and/or CF card interface, etc., but is not limited thereto.

The storage server 3200_1 may further include at least one switch 3230_1 and/or the NIC 3240_1, etc. The switch 3230_1 may selectively connect the processor 3210_1 with the storage device 3250_1 under control of the processor 3210_1, and/or may selectively connect the NIC 3240_1 with the storage device 3250_1, etc.

In at least one example embodiment, the NIC 3240_1 may include a network interface card, a network adapter, and the like. The NIC 3240_1 may be connected to the network 3300 by a wired interface, a wireless interface, a Bluetooth interface, an optical interface, or the like. The NIC 3240_1 may include an internal memory, a digital signal processor (DSP), a host bus interface, and the like, and may be connected to the processor 3210_1 and/or the switch 3230_1 through the host bus interface. The host bus interface may be implemented as one of the above-described examples of the interface 3254_1. In at least one example embodiment, the NIC 3240_1 may be integrated with at least one of the processor 3210_1, the switch 3230_1, and/or the storage device 3250_1, etc.

In the storage servers 3200_1-3200_m and/or the application servers 3100_1-3100_n, the processor may program and/or read data by transmitting at least one command to the storage devices 3150_1 to 3150_n and 3250_1 to 3250_m and/or the memories 3120_1 to 3120_n and 3220_1 to 3220_m, etc. In this case, data may be error-corrected data through an ECC engine, but is not limited thereto. Data is data processed by Data Bus Inversion (DBI) and/or Data Masking (DM), and may include cyclic redundancy code (CRC) information, etc. Data may be data encrypted for security and/or privacy, etc.

The storage devices 3150_1 to 3150_n and 3250_1 to 3250_m may transmit at least one control signal and/or at least one command/address signal to NAND flash memory devices 3252_1 to 3252_m in response to at least one read command received from the processor, etc. Accordingly, when data is read from the NAND flash memory devices 3252_1 to 3252_m, a Read Enable (RE) signal may be input as a data output control signal and may output data to a DQ bus. Data strobe (DQS) may be generated using the RE signal. Command and address signals may be latched on page buffers, depending on a rising edge and/or a falling edge of a Write Enable (WE) signal, etc.

The controller 3251_1 may control the overall operation of the storage device 3250_1. In at least one example embodiment, the controller 3251_1 may include SRAM, but is not limited thereto. The controller 3251_1 may write data to the NAND flash memory device 3252_1 in response to a write command and/or may read data from the NAND flash memory device 3252_1 in response to a read command, but is not limited thereto. For example, write commands and/or read commands may be provided from the processor 3210_1 in the storage server 3200_1, the processor 3210_m in another storage server 3200_m, or the processors 3110_1 to 3110_n in the application servers 3100_1 to 3100_n. The DRAM 3253_1 may temporarily store (e.g., buffer) data to be written to the NAND flash memory device 3252_1 and/or data read from the NAND flash memory device 3252_1, etc. In addition, the DRAM 3253_1 may store metadata. Here, the metadata may be user data and/or data generated by the controller 3251_1 to manage the NAND flash memory device 3252_1, etc. The storage device 3250_1 may include a secure element (SE) for security and/or privacy, but the example embodiments are not limited thereto.

The controller 3251_1 may be any of the storage controllers 100 and 100A described above through FIGS. 1 to 8, and the storage device 3250_1 may be any of the storage devices 200 and 200A described above through FIGS. 1 to 8, but are not limited thereto.

While various example embodiments of the inventive concepts have been particularly shown and described, it will be understood that various changes in form and details may be made therein without departing from the spirit and scope of the following claims.

What is claimed is:

1. A storage device, the storage device comprising:
a non-volatile memory device including a plurality of memory blocks; and
processing circuitry configured to,
determine whether data associated with a memory operation received from a host device is infected with ransomware, the determining whether the data is infected with ransomware including,
determining a first detection result value by calculating a distribution of bit values in the data, and
outputting a second detection result value by detecting a similarity of the memory operation received from the host device with a memory operation transmitted by the processing circuitry to the non-volatile memory device.

2. The storage device of claim 1, wherein the processing circuitry is further configured to:
in response to the first detection result value exceeding the first threshold,
select a memory block to store the data from among the plurality of memory blocks;
store the data in the selected memory block; and
skip the outputting of the second detection result value.

3. The storage device of claim 1, wherein the processing circuitry is further configured to:
perform the outputting of the second detection result value in response to the first detection result value being less than or equal to the first threshold.

4. The storage device of claim 1, wherein the processing circuitry is further configured to:
perform the outputting of the second detection result value in response to the first detection result being less than a second threshold.

5. The storage device of claim 4, wherein the processing circuitry is further configured to:
generate a weight based on results of the calculating the distribution of bit values in the data.

6. The storage device of claim 1, wherein the processing circuitry is further configured to:
in response to the second detection result value exceeding a third threshold,
select a memory block to store the data from among the plurality of memory blocks; and
store the data to the selected memory block.

7. The storage device of claim 1, wherein the processing circuitry is configured to:
in response to the second detection result value being less than or equal to a third threshold and greater than or equal to a fourth threshold,
perform a processing operation to invalidate the data.

8. The storage device of claim 1, wherein the processing circuitry is further configured to:
in response to the second detection result value being less than a fourth threshold,
perform a processing operation to invalidate the data.

9. The storage device of claim 1, wherein the processing circuitry is further configured to:
perform the detecting the similarity of the memory operation received from the host device with the memory operation transmitted by the processing circuitry to the non-volatile memory device based on the first detection result value.

10. The storage device of claim 1, further comprising:
a buffer memory configured to temporarily store data corresponding to a logical address of an overwrite request received from the host device; and
the plurality of memory blocks include user memory blocks and meta memory blocks, the user memory blocks configured to store user data, and the meta memory blocks configured to store meta data.

11. A method of operating a storage device, the method comprising:
receiving a write command from a host device, the write command including data to be written to a storage device;
performing a first ransomware detection operation on the data, the first ransomware detection operation including determining a distribution of bit values included in the data;
performing a second ransomware detection operation based on a first ransomware detection result of the first ransomware detection operation, a first threshold, and a second threshold, the second ransomware detection operation including determining a similarity score of the write command received from the host device and a write command transmitted to non-volatile memory included in the storage device; and
determining whether the data is infected with ransomware based on a second ransomware detection result of the second ransomware detection operation, a third threshold, and a fourth threshold.

12. The method of claim 11, further comprising:
receiving a weight associated with the first ransomware detection result before performing the second ransomware detection operation.

13. The method of claim 12, wherein the performing the first ransomware detection operation further includes:
comparing the first ransomware detection result value with the first threshold and the second threshold comprises; and
in response to the first ransomware detection result exceeding the first threshold,
selecting a memory block to store the data, and
storing the data in the selected memory block.

14. The method of claim 12, wherein the performing the first ransomware detection operation further includes:
generating the weight in response to the first ransomware detection result value being less than or equal to the first threshold and greater than or equal to the second threshold.

15. The method of claim 12, wherein the determining whether the data is infected with ransomware further includes:
selecting a memory block to store the data in response to the second ransomware detection result exceeding the third threshold; and
storing the data in the selected memory block.

16. The method of claim 12, wherein the determining whether the data is infected with ransomware further includes:
performing a processing operation to invalidate the data in response to the second ransomware detection result value being less than or equal to the third threshold and greater than or equal to the fourth threshold or less than the fourth threshold.

17. The method of claim 16, wherein the second ransomware detection operation is selectively performed based on the first ransomware detection result value.

18. A memory controller comprising:
a buffer memory configured to store data corresponding to a logical block address received from a host device; and
processing circuitry configured to,
output a first ransomware detection result value based on a calculation of a distribution of bit values data associated with a memory command received from the host device; and
output a second ransomware detection result value based on a detected similarity of the memory command received from the host device and a memory command transmitted to a non-volatile memory.

19. The memory controller of claim 18, wherein the processing circuitry is further configured to:
in response to the first ransomware detection result value exceeding a first threshold, select a memory block to store the data from among a plurality of memory blocks included in the buffer memory, and store the data in the selected memory block;
output the second ransomware detection result value in response to the first ransomware detection result being less than or equal to the first threshold and greater than or equal to a second threshold; and
in response to the first ransomware detection result value being less than the second threshold, skip performing a garbage collection operation.

20. The memory controller of claim 18, wherein the processing circuitry is further configured to:
in response to the second ransomware detection result value exceeding a third threshold, select a memory block to store the data from among a plurality of memory blocks included in the buffer memory, and store the data in the selected memory block;
in response to the second ransomware detection result value being less than or equal to the third threshold and greater than or equal to a fourth threshold, perform a processing operation to invalidate the data; and
in response to the second ransomware detection result value being less than the fourth threshold, perform a processing operation to invalidate the data.
